(19) United States
(12) Patent Application Publication
(10) Pub. No.: US 2017/0261329 A1
(43) Pub. Date: Sep. 14, 2017

(54) USING IDENTIFICATION TAGS IN A MOBILE DEVICE FOR PROVIDING DIRECTIONS TO A PHYSICAL LOCATION

(71) Applicant: Motorola Mobility LLC, Chicago, IL (US)

(72) Inventors: Jagatkumar Shah, Lake in the Hills, IL (US); Scott Debates, Crystal Lake, IL (US); Mary Hor-Lao, Chicago, IL (US); Douglas A Lautner, Round Lake, IL (US); Hong Zhao, Naperville, IL (US)

(21) Appl. No.: 15/068,673

(22) Filed: Mar. 14, 2016

(51) Int. Cl. G01C 21/34

(52) U.S. Cl. CPC G01C 21/34

(57) ABSTRACT

A method includes providing a plurality of identification tags each associated with one of a plurality of physical locations. First identification data is read from a selected one of the plurality of identification tags designated as a home location on a device. Second identification data is read from at least a subset of the plurality of identification tags other than the selected one on the device. Directions to the home location are provided on a display of the device based on the first identification data and the second identification data.

### BACKGROUND

Field of the Disclosure

The disclosed subject matter relates generally to mobile computing systems and, more particularly, to using identification tags in a mobile device for providing directions to a physical location.

Description of the Related Art

Many individuals transact with a provider to secure limited time usage for a selected physical location. For example, a consumer may secure a parking location, a storage location (e.g., locker), or a personal space location (e.g., seat on a transportation vehicle, such as a bus, train, or plane). Often, the provider maintains a centralized transaction terminal at which an individual may conduct a transaction for securing the usage of the selected physical location. For example, a parking structure or lot may have a central kiosk for an individual to conduct a transaction, such as paying for an already used location or reserving a particular location for a future time interval or usage.

The requirement for a centralized transaction terminal is inconvenient for the individual, as it requires the individual to travel from the particular location being secured to the transaction terminal. In the case of a large facility, the transaction terminal may not be close to the individual's location, such as being on a different level of a multiple level structure. In some instances, due to the need to travel to the transaction terminal, the consumer may become confused regarding how to find the selected physical location relative to the transaction terminal.

Distributing transaction terminals to more locations is generally costly, as hardware and communication services to conduct transactions must be provided at each distributed terminal.

The present disclosure is directed to various methods and devices that may solve or at least reduce some of the problems identified above.

### BRIEF DESCRIPTION OF THE DRAWINGS

The present disclosure may be better understood, and its numerous features and advantages made apparent to those skilled in the art by referencing the accompanying drawings.

FIG. 1 is a simplified block diagram of a device operable to employ identification tags to conduct transactions for securing selected physical locations, in accordance with some embodiments;

FIG. 2 is a flow diagram of a method for employing identification tags to conduct transactions for securing selected physical locations, in accordance with some embodiments;

FIGS. 3-5 are diagrams of example arrangements of physical locations with associated identification tags, in accordance with some embodiments;

FIG. 6 is a flow diagram of a method for employing identification tags to direct a user to a selected physical location, in accordance with some embodiments; and

FIGS. 7-9 are diagrams illustrating how guidance information may be provided on a display of the device, in accordance with some embodiments.

The use of the same reference symbols in different drawings indicates similar or identical items.

### DETAILED DESCRIPTION OF EMBODIMENT(S)

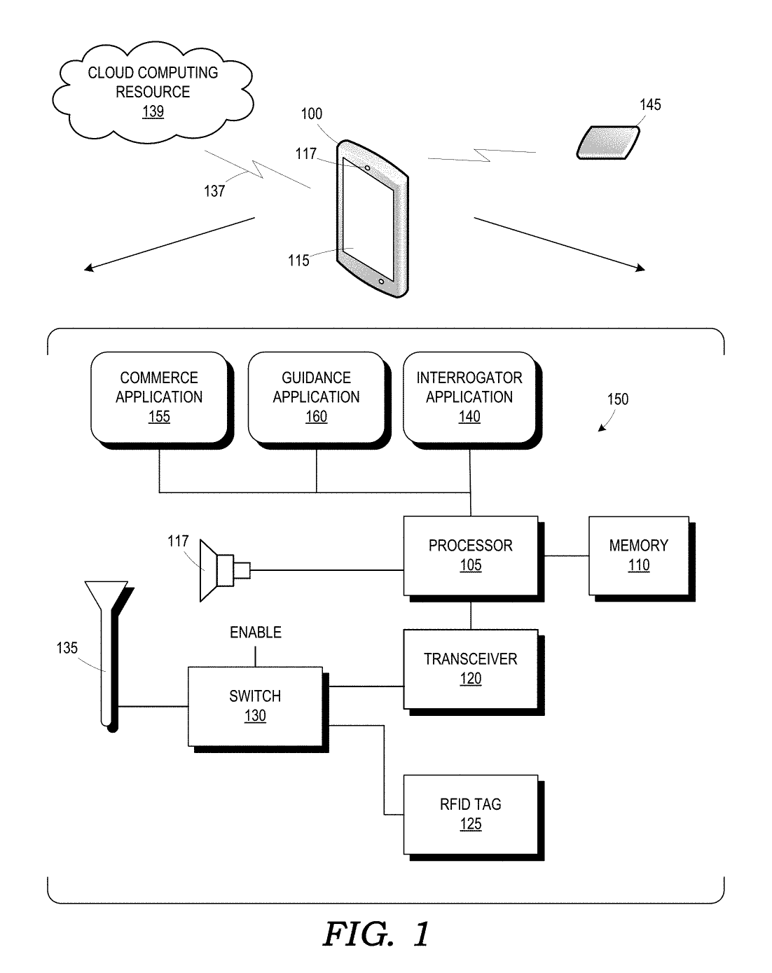

FIGS. 1-9 illustrate example techniques for employing an identification tag associated with a selected physical location to conduct a transaction in a mobile device for the selected location and for providing guidance information to the selected physical location on a display of the device. In one example, a mobile device may read transaction initiation data from the identification tag associated with the selected location, such as a parking space, a storage space, or a personal space. The mobile device may communicate with a provider using the transaction initiation data to complete a transaction regarding the selected physical location, such as reserving the physical location for a predetermined time period or a particular usage. The mobile device may subsequently receive transaction completion data from the provider and store it on the identification tag indicative of the transaction. In some embodiments, a map of nearby identification tags may be employed to direct a user of the mobile device to the selected physical location.

FIG. 1 is a simplistic block diagram of one illustrative example of a device 100 disclosed herein that includes, among other things, a processor 105, a memory 110, a display 115, a speaker 117, a transceiver 120, an identification tag 125 (e.g., a radio frequency identification (RFID) tag), a switch 130, and an antenna 135. The memory 110 may be a volatile memory (e.g., DRAM, SRAM) or a non-volatile memory (e.g., ROM, flash memory, hard disk, etc.). The transceiver 120 transmits and receiving signals via the antenna 135 to implement identification tag reading functionality and to communicate with remote devices. The transceiver 120 may include one or more radios for communicating according to different radio access technologies and over multiple frequency bands (e.g., cellular, Wi-Fi, Bluetooth®, ZigBee, etc.) over a communication line 137. The communication link 137 may have a variety of forms. In some embodiments, the communication link 137 may be a wireless radio or cellular radio link. The communication link 137 may also communicate over a packet-based communication network, such as the Internet. In one embodiment, a cloud computing resource 139 may interface with the device 100 to implement one or more of the functions described herein.

In various embodiments, the device 100 may be embodied in a handheld or wearable device, such as a laptop computer, a handheld computer, a tablet computer, a mobile device, a telephones, a personal data assistants, a music player, a game device, a wearable computing device, and the like. To the extent certain example aspects of the device 100 are not described herein, such example aspects may or may not be included in various embodiments without limiting the spirit and scope of the embodiments of the present application as would be understood by one of skill in the art.

In the device 100, the processor 105 may execute instructions stored in the memory 110 and store information in the memory 110, such as the results of the executed instructions. Some embodiments of the processor 105 and the memory 110 may be configured to implement an interrogator application 140. For example, the processor 105 may execute the interrogator application 140 to query a nearby identification tag 145 associated with a particular physical location to extract information such as identification data, security data, program instructions, etc., to facilitate data exchanges (e.g., commercial transactions) between a user of the device 100 and another party associated with the identification tag 145 over the communication link 137 (e.g., an operator responsible for the physical locations). The processor 105, memory 110, transceiver 120, and interrogator application 140 collectively define an interrogator 150. The particular software and signaling techniques for implementing the interrogator 150 are known to those of ordinary skill in the art, so they are not described in detail herein.

In general, an identification tag 125, 145 is a passive device that does not require a power source to function. An identification tag 125, 145 includes non-volatile memory or logic that stores data, such as identification data, security data, or instruction data, and transmits the stored data using a backscattering modulation technique responsive to a query from an tag interrogator, such as the interrogator 150 in reading the identification tag 145 or from a remote interrogator (not shown) in reading the identification tag 125 in the device 100. The particular circuit elements for constructing identification tags 125, 145 are known to those of ordinary skill in the art, so they are not described in detail herein. The switch 130 allows the identification tag 125 and the interrogator 150 to share the antenna 125 responsive to an enable signal. In some embodiments separate antennas (not shown) may be provided.

The processor 105 and the memory 110 may also be configured to implement a commerce application 155 for conducting transactions associated with the selected physical location and a guidance application 160 for directing a user to the selected location using information from nearby identification tags.

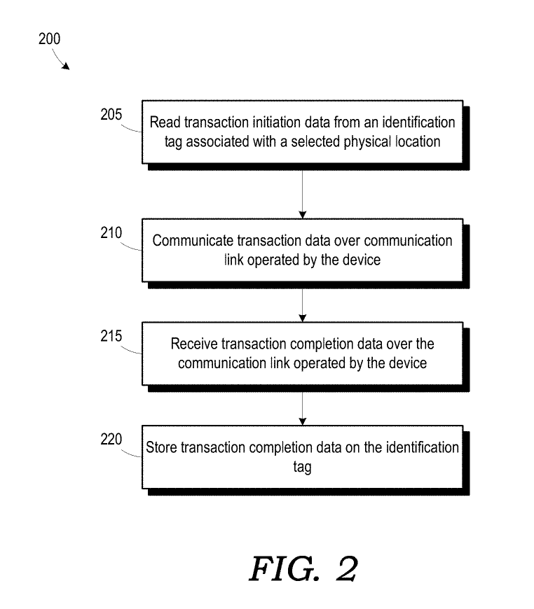

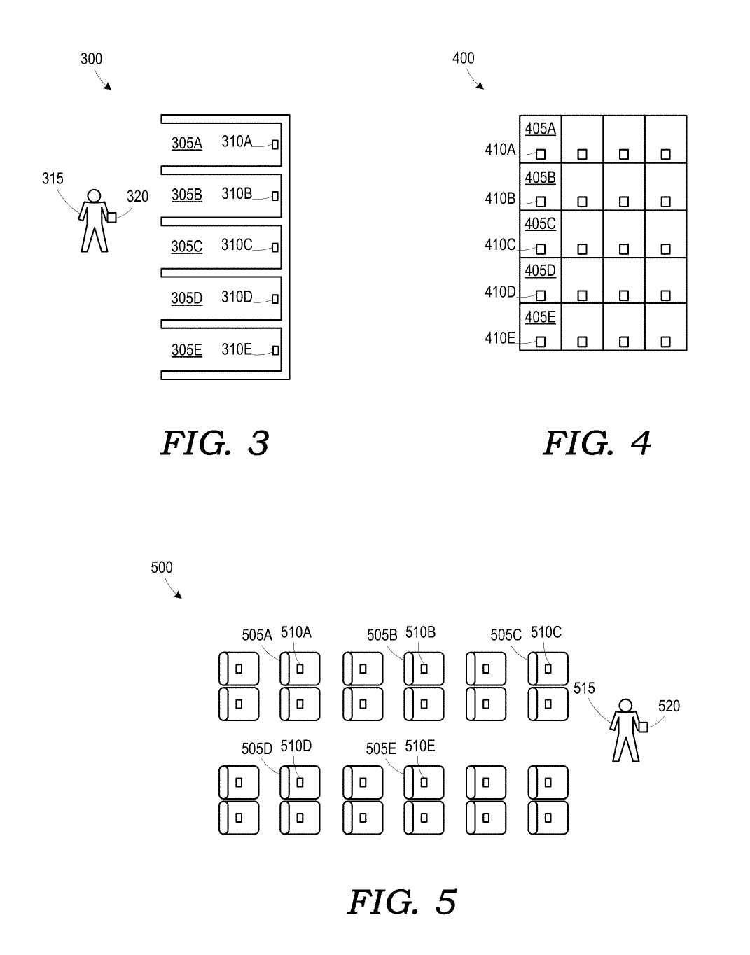

FIG. 2 is a flow diagram of a method for employing identification tags to conduct transactions for securing selected physical locations, in accordance with some embodiments. For purpose of illustrating the method 200 of FIG. 2, FIGS. 3-5 are provided to illustrate example physical location arrangements that may be addressed using techniques described herein.

FIG. 3 is a diagram of a parking facility 300 including a plurality of parking locations 305A-305E, each with an associated identification tag 310A-310E. Only a portion of the parking facility 300 is illustrated. The parking facility 300 may have multiple rows, it may include parking locations arranged along a street, it may have multiple levels, etc. An individual may park a vehicle in one of the parking locations 305A-305E and pay for the parking using the method 200 described below with respect to FIG. 2.

FIG. 4 is a diagram of a storage facility 400 including a plurality of storage locations 405A-405E (e.g., lockers), each with an associated identification tag 410A-410E. An individual pay for the use of a storage location 405A-405E using the method 200 of FIG. 2.

FIG. 5 is a seating diagram of a transport vehicle 500 (e.g., a bus, train, etc.) including a plurality of seats 505A-505E (e.g., lockers), each with an associated identification tag 510A-510E. An individual may select a seat 505A-505E and pay for the transport service using the method 200 of FIG. 2.

Within the context of the method 200 of FIG. 2, examples of a physical location may include one of the parking spaces 305A-305E, one of the storage locations 405A-450E, or one of the seats 505A-505E. The specific arrangements of FIGS. 3-5 are intended to be illustrative, not limiting. Other types of arrangements may be employed. An individual using the device 100 may seek to secure usage of one of the physical locations. For example, the user may desire to obtain a parking space, a storage space, or a seat. The usage period and rate structure may vary depending on the particular location. For example, the user may pay an hourly rate, a daily rate, a fixed fee, etc. for the selected physical location.

Referring to FIG. 2, in method block 205, the user invokes the commerce application 155 to facilitate reading transaction initiation data from an identification tag associated with a selected physical location using the interrogator 150. In some embodiments, the transaction initiation data may include a link or network address (e.g., Internet protocol address) for an operator of the facility including the physical locations. The transaction initiation data may also include a security key. The transaction initiation data allows the device 100 to establish a connection with the operator to facilitate a commercial transaction for usage of the selected physical location. The cloud computing resource 139 may represent a website or application operated by the operator of the facility, where the transaction initiation data connects the device 100 to the cloud computing resource 139. Then user may be provided with feedback regarding the successful reading of the identification tag on the display 115 or via the microphone 117. A user interface may be provided on the display 115 to allow the user to initiate the transaction. The user interface may include a portion of a map highlighting the selected physical location.

In method block 210, the commerce application 155 communicates transaction data with the facility operator over the communication link 137 operated by the device 100, such as by employing the cloud computing resource 139. This exchange may include identification data for the user (e.g., name, address, telephone, auto license place, etc.), rate data from the operator, payment data from the user (e.g., account data, credit card data, payment service data). In some embodiments, the user may have previously contracted with the operator so that only identification data may need to be exchanged to facilitate the transaction. A user ID and/or password may also be requested from the user or managed by the device 100.

In method block 215, the commerce application 155 receives transaction completion data over the communication link operated by the device 100. The transaction completion data represents a receipt for the transaction. In an embodiment where the transaction initiation data included a security key, the transaction completion data may include a unique transaction key.

In method block 220, the commerce application 155 stores the transaction completion data in the identification tag associated with the selected physical location using the interrogator 150. The transaction completion data may include user identification data, usage period, transaction ID number, a ticket, etc.

The use of the device 100 to facilitate the communication with the operator, reduces the need for the operator to provide distributed hardware or communication services to the physical locations. Because the identification tags are passive devices, a power source is not required. The identification tags are inexpensive and easily installed. The storage of the transaction completion data on the identification tag simplifies the payment verification activities of the operator.

As illustrated in FIG. 3, an operator 315 may employ an interrogator 320 and traverse throughout the facility 300 to read the identification tags 310A-310E. In some embodiments, the transaction completion data may also include user identification data, such as a vehicle license plate or other data associated with the user. As the operator 315 traverses a row in the parking facility 300, the interrogator 320 can read the transaction completion data and display the license plate of the vehicle that should be in each location. If a location is used, but there is no transaction completion data or if the license plate does not match, the use may be unauthorized.

In the case of the storage facility 400 of FIG. 4, the storing of the transaction completion data on the in the identification tag 410A-410E (e.g., a unique key) may trigger an event, such as the unlocking of the selected storage location 405A-405E or the release of a key. In some embodiments, the selected storage location 405A-405E may be reserved for a predetermined time period. The commerce application 155 may store data on the identification tag 410A-410E, such as an unlock code to trigger re-opening of the selected storage location 405A-405E prior to the elapsing of the time period without terminating the usage period. A user interface may be provided on the display 115 to allow the user to press a button to unlock and relock the selected storage location 405A-405E one or more times during the contracted usage period.

Within the context of the transport vehicle 500 of FIG. 5, individuals may pay for a seat 505A-505E using the method 200 of FIG. 2 when a seat 505A-505E is selected. The transaction completion data represents a ticket. Again, an operator 515 may walk down the aisle of the vehicle 500 with an interrogator 520 and verify that tickets have been purchased for each of the occupied seats 505A-505E. Some individuals may still use tickets or tokens, or may pay the operator in a conventional manner.

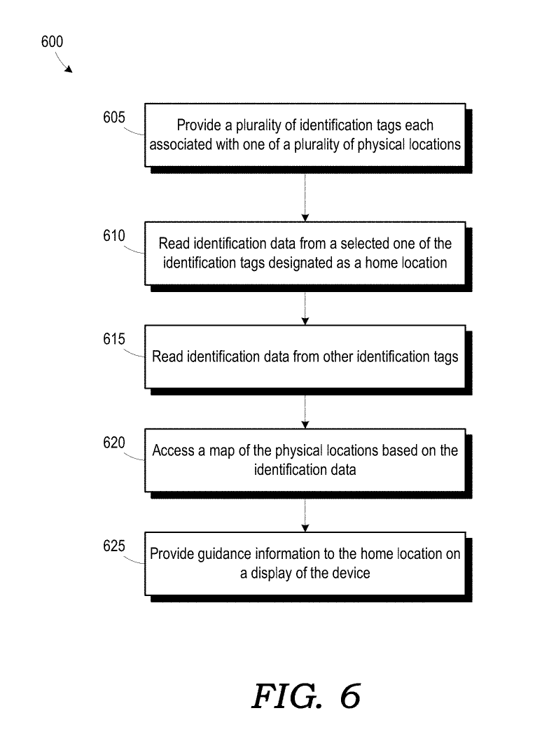

The distributed array of identification tags throughout a facility may also be employed to aid the user in returning to the selected physical location. FIG. 6 is a flow diagram of a method 600 for employing identification tags to direct a user to a selected physical location, in accordance with some embodiments. For purposes of illustration, the use of identification tags for directing the user will be described in reference to a parking facility, such as the facility 300 of FIG. 3.

In method block 605, a plurality of identification tags 310A-310E are provided with each identification tag being associated with one of a plurality of physical locations. In method block 610, identification data is read from a selected one of the plurality of identification tags designated as a home location on the device 100. The interrogator 150 may read the identification data and provide it to the guidance application 160 of FIG. 1. In method block 615 identification data is read by the device 100 from other identification tags 310A-310E.

In method block 620, a map of the plurality of physical locations is accessed using the identification data. The map may cover multiple levels of the facility 300. In some embodiments, the guidance application 160 may generate the map. For example, in instances where GPS data is available, the guidance application 160 may store coordinates for each identification tag 310A-310E read. In some embodiments, the operator may provide a map of the facility 300 that indexes the identification tags 310A-310E of the physical locations. The map or a link to the map may be retrieved by the guidance application 160 over the communication link 137, for example, when the session was established to complete the transaction for reserving the home location. In some embodiments, the map may simply be a sequential list of the identification tags 310A-310E encountered by the device 100 while the user traverses the facility 300.

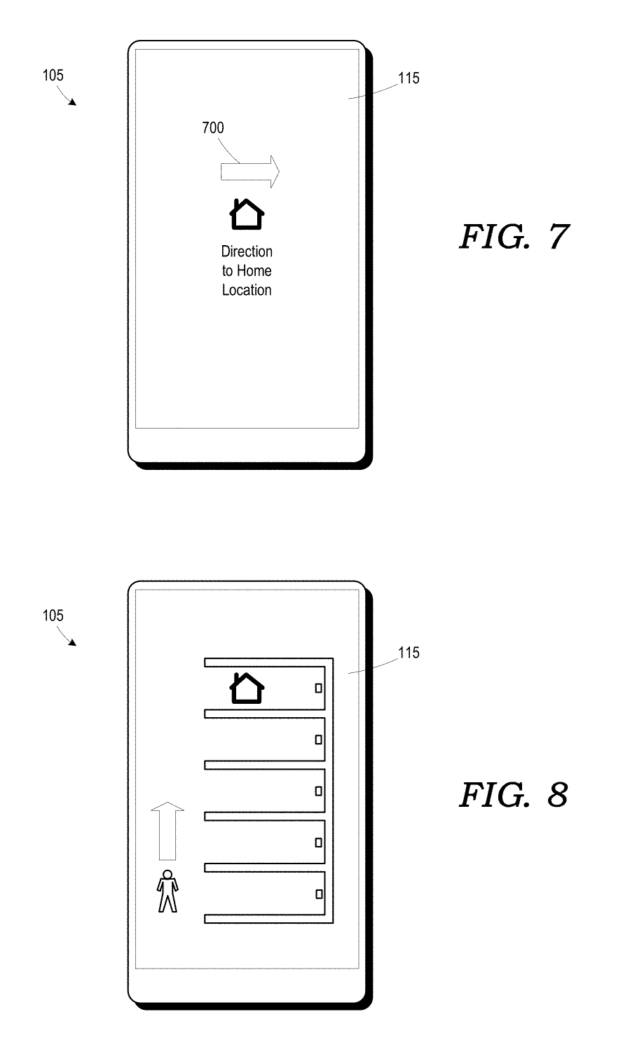

In method block 625, the guidance application 160 provides guidance information to the home location on the display 115 of the device 100 based on the map and the identification data. FIGS. 7-9 are diagrams of the device 100 illustrating example techniques for providing guidance information on the display 115.

In one embodiment illustrated in FIG. 7, the guidance application 160 may provide directional control, such as an arrow 700, on the display 115 directing the user which direction to travel. The guidance application 160 may generate the arrow 700 based on the current location designated by the nearest identification tag and the relationship between the current location and the home location, for example, based on a map provided by the operator and accessed by the device 100 over the communication link 137.

In one embodiment illustrated in FIG. 8, the guidance application 160 may display a portion of the map of the facility 300 indicating the current location and the home location. In embodiments, where the guidance application 160 generates the map, the user's current location and a route to the home location may be displayed. The current location may be determined based on the identification data from the nearest identification tag (e.g., the last identification tag read).

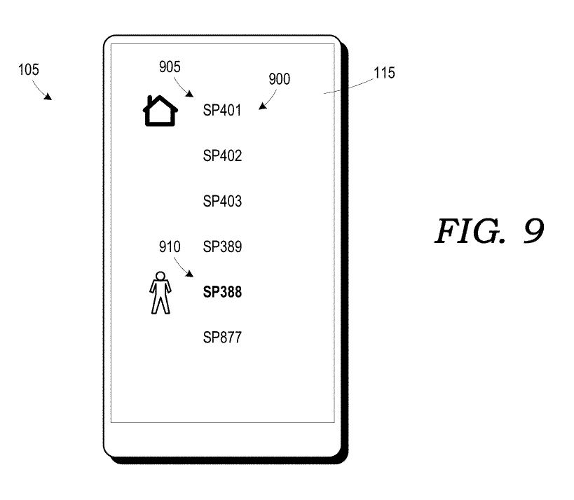

In one embodiment illustrated in FIG. 9, the guidance application 160 may display a list 900 of parking space numbers including the home location 905 and the current location. The user may look for the next parking location on the list, and thus traverse the facility 300 to the home location 905. In some embodiments, the guidance application 160 may just display the next location on the list rather than the entire or portion of the list.

In embodiments where the map includes a sequential list of identification tags encountered by the user after leaving the home location, the guidance application 160 may display the identification data (e.g., parking space number) of the next location on the list on the return route. For example, a sequential list of parking spaces may be generated as the user leaves the facility 300. Upon re-entering the facility 300, the guidance application 160 may read an identification tag of a nearby parking space and find that space on the list. If a matching entry does not exist, the user may be provided with the last entry in the list indicating the exit point of the facility 300. Once, the user finds that space, the guidance application 160 may process the list in reverse order, directing the user back to the home location, which represents the first entry in the list.

In some embodiments, certain aspects of the techniques described above may be implemented by one or more processors of a processing system executing software. The techniques may be implemented by executing software on a computing device, such as the processor 105 of FIG. 1, however, such methods are not abstract in that they improve the operation of the device 100 and the user's experience when operating the device 100. Prior to execution, the software instructions may be transferred from a non-transitory computer readable storage medium to a memory, such as the memory 110 of FIG. 3.

The software may include one or more sets of executable instructions stored or otherwise tangibly embodied on a non-transitory computer readable storage medium. The software can include the instructions and certain data that, when executed by one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

A method includes providing a plurality of identification tags each associated with one of a plurality of physical locations. First identification data is read from a selected one of the plurality of identification tags designated as a home location on a device. Second identification data is read from at least a subset of the plurality of identification tags other than the selected one on the device. Directions to the home location are provided on a display of the device based on the first identification data and the second identification data.

A device includes a display, an antenna, an interrogator coupled to the antenna, a transceiver coupled to the antenna to operate a communication link, and a processor coupled to the display, the transceiver, and the interrogator. The processor is to read first identification data from a selected one of a plurality of identification tags. Each of the plurality of identification tags is associated with one of a plurality of physical locations. The processor is to read second identification data from at least a subset of the plurality of identification tags other than the selected one on the device and provide directions to the home location on a display of the device based on the first identification data and the second identification data.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed is:

1. A method, comprising:
providing a plurality of identification tags each associated with one of a plurality of physical locations;
reading first identification data from a selected one of the plurality of identification tags designated as a home location on a device;
reading second identification data from at least a subset of the plurality of identification tags other than the selected one on the device; and
providing directions to the home location on a display of the device based on the first identification data and the second identification data.

2. The method of claim 1, further comprising accessing a map of the physical locations on the device, wherein providing the directions further comprises providing the directions based on the map.

3. The method of claim 2, wherein providing the directions comprises displaying at least a portion of the map.

4. The method of claim 2, further comprising generating the map based on the second identification data.

5. The method of claim 4, wherein the map comprises a list of physical locations associated with the identification tags in the subset.

6. The method of claim 5, wherein providing the directions comprises:
determining a current location of the device responsive to reading second identification data matching a first entry in the list;
determining a next location representing a second entry in the list next to the first entry; and
displaying second identification data associated with the second entry on the display.

7. The method of claim 4, wherein generating the map comprises storing a location of each of the identification tags in the subset.

8. The method of claim 1, further comprising receiving the map using a communication link operated by the device.

9. The method of claim 1, wherein providing the directions comprises displaying a directional control on the display.

10. The method of claim 1, wherein reading the first and second identification data comprises reading the first and second identification data using an interrogator of the device.

11. The method of claim 1, further comprising:
reading transaction initiation data from the selected one of the identification tags on the device;
communicating transaction data associated with the home location using a communication link operated by the device;
receiving transaction completion data using the communication link; and
storing transaction completion data on the selected one of the identification tags.

12. A device, comprising:
a display;
an antenna;
an interrogator coupled to the antenna;
a transceiver coupled to the antenna to operate a communication link;
a processor coupled to the display, the transceiver, and the interrogator to read first identification data from a selected one of a plurality of identification tags, wherein each of the plurality of identification tags is associated with one of a plurality of physical locations, read second identification data from at least a subset of the plurality of identification tags other than the selected one on the device, and provide directions to the home location on a display of the device based on the first identification data and the second identification data.

13. The device of claim 12, wherein the processor is to access a map of the physical locations on the device, wherein the processor is to provide the directions based on the map.

14. The device of claim 13, wherein the processor is to display at least a portion of the map on the display.

15. The device of claim 13, wherein the processor is to generate the map based on the second identification data.

16. The device of claim 15, wherein the map comprises a list of physical locations associated with the identification tags in the subset.

17. The device of claim 16, wherein the processor is to provide the directions by determining a current location of the device responsive to reading second identification data matching a first entry in the list, determining a next location representing a second entry in the list next to the first entry, and displaying second identification data associated with the second entry on the display.

18. The device of claim 15, wherein the processor is to store a location of each of the identification tags in the subset.

19. The device of claim 13, wherein the processor is to receive the map using the communication link.

20. The device of claim 12, wherein the processor is to read transaction initiation data from the selected one of the identification tags using the interrogator, communicate transaction data associated with the home location using the communication link, receive transaction completion data using the communication link, and store transaction completion data on the selected one of the identification tags using the interrogator.
